(19) United States
(12) Patent Application Publication
(10) Pub. No.: US 2010/0086241 A1
(43) Pub. Date: Apr. 8, 2010

(54) Method And Apparatus For Making Bags

(75) Inventor: Curt A. Frievalt, Chesapeake, VA (US)

Correspondence Address: GEORGE R CORRIGAN, 5 BRIARCLIFF COURT, APPLETON, WI, 54915, US

(73) Assignee: CMD Corporation, Appleton, WI (US)

(21) Appl. No.: 12/245,225

(22) Filed: Oct. 3, 2008

(51) Int. Cl. B65D 33/28; B31B 1/90

(52) U.S. Cl. 383/75; 493/225

(57) ABSTRACT

A drawtape bag includes a generally closed bottom, a generally open top, and closed sides connecting the bottom and the top. A drawtape hem, with a drawtape therein, is disposed along the top. There are a plurality of knockouts within the hem. A method and machine for of making such a drawtape bag includes forming at least two notches in the film with a notch section, and forming a plurality of knockouts in the film with a knockout section. A drawtape hem is formed in a drawtape section, which also inserts a drawtape.

### FIELD OF THE INVENTION

The present invention relates generally to the art of bags, and equipment and methods to make rolls of bags. More specifically, it relates to drawtape bags, and equipment and methods to make rolls of drawtape bags from film such as flattened blown film tubes.

### BACKGROUND OF THE INVENTION

There are many different types of bags with varied uses, and many different machines and methods to make such bags. One example of a bag is a drawtape bag, such as that used for leafs or kitchen trash cans. Equipment to make drawtape bags is well known, such as a CMD 1279GDS®, or that described U.S. Pat. Nos. 5,857,953 and 5,797,828, Selle, hereby incorporated by reference. Generally speaking, drawtape machines includes a number of functional sections that operate on a two layer film. Two layer film, as used herein, is a film that is two layers, and can be a tube, detached layers, or a single layer folded upon itself.

A drawtape bag machine typically includes, going from upstream to downstream, a notch section, a drawtape section, a drum or side seal section, a folding section having one or more folders, and a winder or packager. Downstream, as used herein, refers to the direction the film travels through the machine. Notch section, as used herein, refers to a section of a bag machine that imparts a notch to the film. Drawtape section, as used herein, refers to a section of a bag machine that forms a hem and/or inserts a drawtape. Side seal section, or seal section, as used herein, refers to a section of a bag machine that imparts side seals or seals to the film. Machine section, as used herein, refers to a section of a bag machine that performs one or more functions. A section can be in one physical location, or distributed among several physical locations, and two section can be at one physical location. These sections cooperate to form a bag such as that shown in FIG. 1. Bag 100 includes a hem 101 and a separating notch 102 (bag 100 is flattened and is two layers, and a second separating notch is behind separating notch 102 in the layer not seen). A drawtape is disposed within hem 101 and may be seen through separating notch 102.

The notch section forms a notch in the bag by punching a hole in the film. The punched out portion is typically saved for reuse, particularly as the cost of resin (used to make film) increases. The notch becomes a separating notch, and is used by the end user to access the drawtape. Notch, as used herein, refers to a portion of film removed from what becomes, at least in part, the top of the bag. Separating notch, as used herein, is a notch used in drawtape bags that allows access to the drawtape by the user.

After the notch is made a hem is created and a drawtape inserted within the hem. Then side seals are made in the cross machine direction. After seals are made the bag is folded, usually two or three times, in the cross machine direction, so that the bag is an acceptable width for selling and handling. Then the bag is wound (and possibly separated) or folded for packaging. U.S. Pat. No. 5,390,875, Gietman, Jr., et al. (hereby incorporated by reference) shows a rotary overlap bag machine that receives a film of formed bags, and separates and/or overlaps bags to form a roll of bags.

As stated above, resin used to make film is expensive, and thus it is desirable to reduce costs by reducing the amount of film used to make bags, and by reusing scrap film when possible. Accordingly, a drawtape bag made so as to increase the amount of reusable film is desirable, as is a method and apparatus for making such bags.

### SUMMARY OF THE PRESENT INVENTION

According to a first aspect of the invention a drawtape bag includes a generally closed bottom, a generally open top, and closed sides connecting the bottom and the top. A drawtape hem, with a drawtape therein, is disposed along the top. There are a plurality of knockouts within the hem.

According to a second aspect of the invention a method of making a drawtape bag from a flattened two layer film, includes forming at least two notches in the film and forming a plurality of knockouts in the film. A drawtape hem is formed such that the notches forms two separating notches and the knockouts are within the hem. A drawtape is inserted into the hem side seals are made across the web.

According to a third aspect of the invention a bag machine for making drawtape bags from a flattened two layer film includes a notch section, a knockout section, a drawtape section, and a side seal section. The drawtape section is downstream of the notch section and the knockout section and the side seal section is downstream of the drawtape section.

The bag of claim 1 wherein the hem has at least one separating notch therein, and/or the knockouts are not within any part of the separating notch in various embodiments.

Each knockout is centered between an inner hem edge and an outer hem edge, and/or the knockouts are not within any part of the side seals in other embodiments.

The combined area of the knockouts comprise between about 10% and about 15% of the area of the hem, more than 10% of the area of the hem, more than 5% of the area of the hem, and/or less than 20% of the area of the hem on various embodiments.

No knockout is closer than one-half a knockout length to any of another knockout, the inner hem edge, the outer hem edge, the side seals and the separating notch in various embodiments.

The bag is a leaf bag in another embodiment.

The knockouts and separating notches are formed so as not to overlap in another embodiment

The bag machine includes a folder and/or winder in other embodiments.

Other principal features and advantages of the invention will become apparent to those skilled in the art upon review of the following drawings, the detailed description and the appended claims.

### BRIEF DESCRIPTION OF THE DRAWINGS

FIG. 1 is a prior art drawtape bag;

FIG. 2 is drawtape in accordance with the present invention; and

FIG. 3 a bag machine in accordance with the present invention,

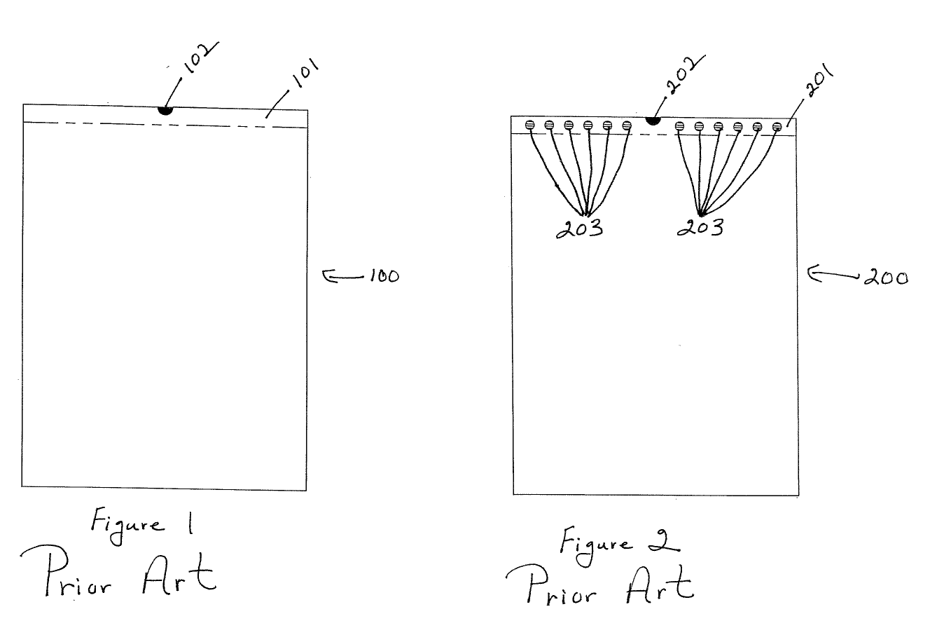

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular drawtape bag, and a particular bag machine with particular components, it should be understood at the outset that the invention may be implemented using other machines and other equipment to produce other bags.

Generally, the invention provides for increasing the amount of film that can be reused, thus decreasing cost per bag. Specifically, the invention provides for knocking out portions of the hem in a drawtape bag, so that the knockouts may be reused. Knockouts, as used herein, includes a portion of film that is removed from what becomes the hem by cutting, punching, etc, and wherein the film is not removed from what becomes the top of the drawtape bag. Thus, a notch which spans the top of the hem/bag, cannot be a knockout. Top of a drawtape bag, as used herein, is the upper edge of the drawtape hem that forms the upper edge of the bag.

FIG. 2 shows a bag 200 in accordance with the present invention, and includes hem 201 along the top of bag 200, separating notch 202 as did the prior art drawtape bags. However, bag 200 includes knockouts 203 as well. The film from knockouts 203 is reused to reduce material cost. Bag 200 is a flattened bag, and in the preferred embodiment there are knockouts in the layer not visible, just as in the layer seen. Along the top, as used herein, means generally near the top. Hem 201 is folded over and thus two layers. Therefore, there are four layers of hem—two for the top bag layer, and two for the bottom, not visible, bag layer.

In accordance with the preferred embodiment, the knockouts are located in such a way as to reduce the likelihood of the hem failing (tearing, e.g.). Specifically, in the preferred embodiment knockouts 203 are within in hem 201, and preferably centered between the inner hem edge and the out hem edge. Within the hem, as used herein, means between edges of the hem formed be sealing and by the top of the bag. Inner hem edge, as used herein, is the sealed edges of the hem that are below and generally parallel to the top of the bag. Outer hem edge, as used herein, is the edge of the hem that is also the top of the bag, and is typically a creased edge, not a sealed edge. Thus, centered between the edges of the hem results in the knockouts being equidistant from potential tearing points such as the bottom of the hem and the top of the hem/bag.

Also, the preferred embodiment provides that knockouts 203 are not near, and preferably not overlapping, either the side seals or the separating notches to avoid weakening the hem. Overlap, as used herein with respect to knockouts and notches, refers to some portion of the knockout being located in a position where it would also be part of the notch, had it not been knocked out, or visa-versa.

Dimensions of bag 200 are given, but are not limiting. For a leaf bag (used to store leaves and lawn waste) or trash bag, for example, bag 200 has a generally closed bottom, a generally open top, and closed sides (formed by side seals). Generally closed bottom, as used herein, includes a bottom that is closed sufficiently for the purpose of the bag. For example, a leaf bag may have gaps in the seal and still be closed. Generally open top, as used herein, includes a top open sufficiently for the purpose of the bag. Closed sides, as used herein, includes a side closed sufficiently for the purpose of the bag.

Bag 200, in the preferred embodiment, is 44 inches tall (form the bottom of the bag to the top of the hem), and 33 inches wide. The hem extends the entire width of the bag, and thus the hem length is also 33 inches. Hem length, as used herein, refers to the length of the hem in the direction of the bag width. Separating notch 202 is about 1.75 inches in diameter, and is a half circle. The other half of the circle is the notch on the inner side of hem 201. The circle forming the notch has an area of just over 2.4 sq. in. The bottom layer of bag 200, not shown, also includes a notch. Thus, the total area of the film removed for nothing is 4.81 sq. in. per bag.

There are 12 knockouts 203 on the each of the two layers of hem 201. The knockouts are shaped so as to reduce tension and distribute force along their edges. They are circles in the embodiment shown, but are other shapes in other embodiments, such as oval, oblong, etc. The chosen shape is not important, so long as it withstands the forces exerted on the hem without tearing or failing. Each knockout is a circle with a diameter of 25 mm (0.9843 in). Thus, 12 knockouts have a total combined area for a given layer of film, of 9.13 sq. in. There are two layers per hem, and the hem for the front and back layer of the bag, so the total area is about 36.5 sq. in. Thus, the total area of reusable film (the notch plus knockouts) is about 41.3 sq in. This is more than eight times as much as the area of the prior art notch.

Hem 201 has a width of 2 inches. Thus the total area of hem 201 is 2×33=66 sq. in. For four layers of film there are 264 sq. in. The knockouts and notch combine to be 15-16% of the hem area. The knockouts alone are between 13% and 14% of the hem area. Thus, it may be seen the saving are relatively great.

Knockouts 203 are positioned to reduce the likelihood of hem failure. They are located 2.25 in. center to center, with a diameter of 0.9843 in., to leave a gap of 1.2657 between knockouts. The knockouts are centered in hem 201, and have a gap of 0.51 inches between the closest spot on each knockout to the inner and outer edges of hem 201. Knockouts 203 are also 1.7 inches from the side seals, and 1.8 in. from the notch. Thus, it can be seen that knockouts 103 do not overlap with other knockouts, notch 202, the side seals, or the edges of hem 201. Moreover, knockouts 103 are no closer to the any of another knockout, the edges of hem 201, the notch, or the side seals than one-half a knockout length (0.49 in). Knockout length, as used herein, is the length of a given knockout in a given direction.

Alternatives provide for different dimensions, including spacing and percentages knocked out. For example, with an oval knockout having a length of about 1.32 in., and the same width as above, results in nearly 20% of the hem being knocked out. Similarly, a circular knockout with a diameter of about 0.84 in. results in a 10% knockout, and a diameter of 0.6 in. results in about a 5% knockout. Other dimensions are also contemplated, and consideration should be given to film strength and the forces exerted on the hem. Another embodiment contemplates using knockouts of different or varying sizes and/or shapes within a hem, such as alternating between large and small knockouts. Another embodiment provides for knocking out letters, which could be used for advertising.

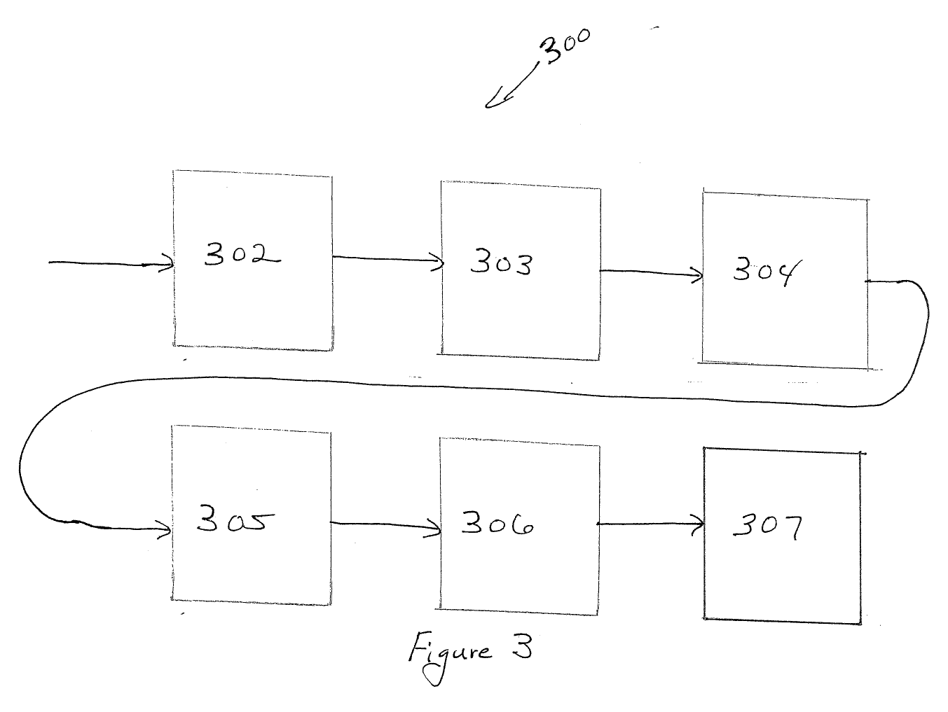

Turning now to FIG. 3, a bag machine in accordance with the present invention includes moving from upstream to downstream, a notch section 302, a knockout section 303, a drawtape section 304, a seal section 305, a folder 306 and a winder 307. These sections cooperate to form bag 200. Knockout section, as used herein, refers to a section of a bag machine that imparts a knockout to the film. A controller is also included, and may be located within another section, such as section 303, or may be in a distinct location. Controller, as used herein, refers to the portions of a bag machine that performs control functions, and can be in one physical location, or distributed among several physical locations. Different sections may be combined in one physical location, or a single section may be distributed over several location.

Notch section 302 may be in accordance with the prior art, and is preferably that found in of the CMD 1279 GDS®. Knockout section 303 may operate similarly to notch section 302, and can include a punch, die, etc. Sections 302 and 303 may be in the opposite order or combined at a single location and/or be part of a single section. Form part of a single section, as used herein, refers to a single section that performs multiple functions, and thus has multiple subsections.

Drawtape section 304 receives the notched and knocked out film, is preferably that found in the CMD 1270GDS®, and includes the tape insertion and the hem forming. The hem is formed by folding over an edge of the film, as is known in the art.

Sealing section 305 preferably includes a rotary drum, such as that shown in U.S. Pat. No. 7,326,162, Sauder, et al. (hereby incorporated by reference) or CMD 5213 Rotary Bag Machine®. Alternatives provide for using advanced bag machines that create the seal and a perforation at the same time, such as that shown in US Patent Application 2008-0093018 A1 (Selle), hereby incorporated by reference. Sealing section 205 operates in accordance with the prior art.

Winder 307 is, in the preferred embodiment, in accordance with prior art machines such as that shown with U.S. Pat. No. 5,390,875, a CMD model 4213RO® winder, and/or US Patent Application 20080067279A1, Selle, (hereby incorporated by reference). Winder 307 is a packager in alternative embodiments.

Notch section 302 typically is servo controlled, because, given the size of notch 202 relative to hem 201, it is important to precisely locate the notch to avoid weakening the hem. Knockout section 203 preferably produces knockouts of a sufficiently small size that they need not be precisely located, thus the expense of a servo control may be avoided. For example, a ball and die, rule and die, rotary/non rotary male and female punch may be used. The punches are not made at the seal and notch (by suspending rotation, lifting the wheel, etc.), so that the knockout section operates on different areas of the hem than the seal section and the notch section. Operate on different areas of the film, as used herein with respect to multiple machine sections, means that one section does not impart seals, notches, knockouts, etc to the same location as the other section. Thus, for example, a notch would not overlap a knockout.

Control of the knockout section need only be sufficient to insure integrity of the hem. Control of the remainder of the machine can be that of the prior art. Given the relatively imprecise control need for knockout section 303, the same controller used for the rest of the machine can control section 303, or a low cost add-on controller can be used for section 303.

Alternatives provide for forming the knockouts and the notch at the same time, other methods of forming the knockouts, other shapes, other orders, and others dimensions. Numerous modifications may be made to the present invention which still fall within the intended scope hereof. Thus, it should be apparent that there has been provided in accordance with the present invention a method and apparatus fora drawtape bag, machine and method that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A drawtape bag comprising:
a generally closed bottom;
a generally open top;
closed sides connecting the bottom and the top;
a drawtape hem along the top, wherein there are a plurality of knockouts within the hem; and
a drawtape, disposed within the drawtape hem.

2. The bag of claim 1 wherein the hem has at least one separating notch therein.

3. The bag of claim 1, wherein the knockouts are not within any part of the separating notch.

4. The bag of claim 1, wherein each knockout is centered between an inner hem edge and an outer hem edge.

5. The bag of claim 1, further comprising, side seals extending from the top to the bottom of the bag, wherein the knockouts are not within any part of the side seals.

6. The bag of claim 1, wherein the combined area of the knockouts comprise between about 10% and about 15% of the area of the hem.

7. The bag of claim 1, wherein the combined area of the knockouts comprise more than 10% of the area of the hem.

8. The bag of claim 1, wherein the combined area of the knockouts comprise more than 5% of the area of the hem.

9. The bag of claim 1, wherein the combined area of the knockouts comprise less than 20% of the area of the hem.

10. The bag of claim 1, further comprising, side seals extending from the top to the bottom of the bag, and wherein the hem has an inner hem edge and an outer hem edge, and a separating notch, and wherein each knockout has a knockout length in the direction of a hem length, and wherein no knockout is closer than one-half the knockout length to any of another knockout, the inner hem edge, the outer hem edge, the side seals and the separating notch.

11. The bag of claim 1 wherein the bag is a leaf bag.

12. A method of making a drawtape bag from a flattened two layer film, comprising:
forming at least two notches in the film;
forming a plurality of knockouts in the film;
forming a drawtape hem such that the notches forms two separating notches and the knockouts are within the hem;
inserting a drawtape into the hem; and
imparting side seals across the web.

13. The method of claim 12, wherein the method is controlled such that the knockouts and separating notches are formed so as not to overlap.

14. The method of claim 13, wherein the method is controlled such that the knockouts are formed and the hem is formed such that the knockouts are centered between an inner hem edge and an outer hem edge.

15. The method of claim 14, wherein the hem has a hem area, and wherein forming a plurality of knockouts comprises knocking out between about 10% and about 15% of the hem area.

16. The method of claim 14, wherein the hem has a hem area, and wherein forming a plurality of knockouts comprises knocking out more than 10% of the hem area.

17. The method of claim 16, wherein the hem has a hem area, and wherein forming a plurality of knockouts comprises knocking out less than 20% of the hem area.

18. The method of claim 14, wherein the hem has a hem area, and wherein forming a plurality of knockouts comprises knocking out more than 5% of the hem area.

19. The method of claim 12, wherein the method is controlled such that the knockouts and separating notches are formed so as not to overlap.

20. The method of claim 13, wherein the method is controlled such that the knockouts are formed with a knockout length in the direction of a hem length, the notches are formed, the hem is formed with an inner hem edge and an outer hem edge, and the side seals are imparted, such that no knockout is closer than one-half the knockout length to any of another knockout, the inner hem edge, the outer hem edge, the side seals and the separating notches.

21. The method of claim 1 wherein forming the knockouts occurs after forming the at least two notches.

22. A bag machine for making drawtape bags from a flattened two layer film that moves through the machine in a machine direction from upstream to downstream, comprising:
a notch section, disposed to receive the film;
a knockout section, disposed to receive the film;
a drawtape section, disposed to receive the film downstream of the notch section and the knockout section; and
a side seal section, disposed to receive the film downstream of the drawtape section.

23. The bag machine of claim 22, further comprising a winder disposed to receive the film downstream of the side seal section.

24. The bag machine of claim 23, wherein the notch section and the knockout section are disposed to operate on different areas of the film.

25. The bag machine of claim 24, wherein the knockout section is disposed and the hem section is disposed such that the knockouts are centered between an inner hem edge and an outer hem edge.

26. The bag machine of claim 24, wherein the hem has a hem area, and wherein the knockout section is disposed to knockout out between about 10% and about 15% of the hem area.

27. The bag machine of claim 24, wherein the hem has a hem area, and wherein the knockout section is disposed to knockout out more than 10% of the hem area.

28. The bag machine of claim 27, wherein the hem has a hem area, and wherein the knockout section is disposed to knockout out less than 20% of the hem area.

29. The bag machine of claim 24, wherein the hem has a hem area, and wherein the knockout section is disposed to knockout out more than 5% of the hem area.

30. The bag machine of claim 29, further comprising a controller, connected to the knockout section and the notch section, wherein the knockout section forms knockouts having a knockout length in the direction of a hem length, and wherein the hem is formed with an inner hem edge and an outer hem edge, and controlling the machine such that the knockout section does not operate closer than one-half the knockout length to any film operated on by the drawtape section, the notch section, and the side seal section.

31. The bag machine of claim 30, wherein the notch section is upstream of the knockout section, and wherein the notch section and the knockout section form part of a single section.

32. The bag machine of claim 30, wherein the notch section is downstream of the knockout section, and wherein the notch section and the knockout section form part of a single section.

33. A bag machine for making drawtape bags from a flattened two layer film that moves through the machine in a machine direction from upstream to downstream, comprising:
notch means for forming at least two notches in the film, disposed to receive the film;
knockout means forming a plurality of knockouts in the film, disposed to receive the film;
drawtape means for forming a drawtape hem such that the notches forms two separating notches and the knockouts are within the hem, and for inserting a drawtape into the hem, disposed to receive the film downstream of the notch means and the knockout means; and
means for imparting side seals across the web, disposed to receive the film downstream of the drawtape means.

34. The bag machine of claim 33, further comprising a controller means, connected to the notch means and the knockout means, for controlling the machine such that the knockouts and notches are formed so as not to overlap.

35. The bag machine of claim 34, wherein the notch means is disposed such that the knockouts are centered between an inner hem edge and an outer hem edge.

36. The bag machine of claim 35, wherein the notch means is disposed such that the knockouts and notches do not overlap.
